(19) United States
(12) Patent Application Publication
(10) Pub. No.: US 2026/0341871 A1
(43) Pub. Date: Oct. 29, 2026

(54) BATTERY PACK

(71) Applicant: Samsung SDI Co., Ltd., Yongin-si (KR)

(72) Inventors: Jörg KILLMANN, Graz (AT); Peter REININGER, Hart bei Graz (AT); Juan Manuel GUTIERREZ DUARTE, Graz (AT); Bostjan FERK, Sladki Vrh (SI)

(21) Appl. No.: 19/427,891

(22) Filed: Dec. 19, 2025

(30) Foreign Application Priority Data
Apr. 24, 2025 (EP) 25172355.7

(51) Int. Cl. H01M 50/242; H01M 50/204; H01M 50/289

(52) U.S. Cl. CPC H01M 50/242; H01M 50/289; H01M 50/204

(57) ABSTRACT

A battery pack including: a battery pack housing having accommodation spaces respectively accommodating battery cell stacks therein; a separation wall separating adjacent ones of the battery cell stacks; a pressure wall having a first side contacting end portions of the battery cell stacks and connected to or integrally formed with the separation wall; and a reinforcement structure on a second side of the pressure wall for reinforcing the separation wall. The reinforcement structure includes: an outer wall spaced from the pressure wall and extending parallel to the pressure wall; and a plurality of stiffening ribs between the pressure wall and the outer wall. The stiffening ribs having a first contact height in contact with the pressure wall and a second contact height in contact with the outer wall less than a total pressure wall height to an upper edge of the pressure wall.

### CROSS-REFERENCE TO RELATED APPLICATION

The present application claims priority to and the benefit of European Patent Application No. 25172355.7, filed on Apr. 24, 2025, in the Korean Intellectual Property Office, the entire disclosure of which is incorporated herein by reference.

### BACKGROUND

### 1. Field

Aspects of embodiments of the present disclosure relate to a battery pack.

### 2. Description of the Related Art

A battery pack is a set of any number of (usually identical) battery modules or single battery cells. The battery modules, and respectively the battery cells therein, may be configured in a series, parallel, or a mixture of both to provide the desired voltage, capacity, and/or power density. Components of a battery pack include the individual battery modules and the interconnects, which provide electrical conductivity between the battery modules.

Mechanical integration of a battery pack is achieved by appropriate mechanical connections between the individual components, for example, between the battery modules and between them and a supporting structure of the vehicle. These connections should remain functional and safe during the average service life of the battery system. Further, installation space and interchangeability specifications should be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors, such as bolts or screws. In some cases, the battery modules are confined by fastening side plates to lateral sides of the carrier framework. Further, cover plates may be fixed atop and below the battery modules.

The carrier framework of the battery pack is mounted to a carrying structure of the vehicle. When the battery pack is to be fixed at the bottom of the vehicle, the mechanical connection may be established from the bottom side by, for example, bolts passing through the carrier framework of the battery pack. The framework is generally made of aluminum or an aluminum alloy to reduce the overall weight of the construction.

Conventional battery systems, despite any modular structure, usually include a battery housing that acts as an enclosure to seal the battery system against the environment and provides structural protection of the battery system's components. Housed battery systems are usually mounted as a whole into their application environment, such as an electric vehicle. Thus, the replacement of defect system parts, for example, a defective battery submodule, requires dismounting the entire battery system and removal of its housing first. Even defects in small and/or cheap system parts may require dismounting and replacement of the entire battery system and its separate repair. Because high-capacity battery systems are expensive, large, and heavy, this procedure is burdensome and the storage, for example, in the mechanic's workshop, of the bulky battery systems is difficult.

As the location for the active and passive components of a battery system, the battery housing plays a critical role in the functionality, safety, and service life of the energy storage system. The battery housing protects the sensitive components from harmful environmental influences, such as water, moisture, and dust, and is therefore crucial for long-term safe and reliable operation. Because traction batteries are typically located outside the vehicle cabin, usually in the floor area, the housing is directly exposed to extreme environmental conditions, such as temperature fluctuations, humidity, splash water, salt spray, dust, and stone chipping. High mechanical stability and corrosion resistance are therefore essential, even under aggressive external conditions. In addition to the environmental influences, which primarily affect the surface of the housing or the tightness of the housing, the internal and external fastening systems are of particular importance under vehicle operating conditions.

The battery cells of a battery cell stack may be subject to expansion due to various reasons including swelling, aging, and/or charging. Due to such expansion, the battery cell stack in the battery pack housing may exert a force, for example, in a longitudinal direction, on the battery pack housing. For example, in cell-to-pack type battery pack housings, these forces are directly transferred to the battery pack housing.

Such forces may cause high stresses at critical areas or locations of the battery pack housing. For example, separation walls between the battery cell stacks are critical components regarding mechanical stability. Reinforcement structures including rib structures have been used to increase the mechanical robustness of the battery pack housing.

### SUMMARY

The present disclosure is defined by the appended claims and their equivalents. The description that follows is subject to this limitation. Any disclosure lying outside the scope of the claims and their equivalents is intended for illustrative as well as comparative purposes.

The reinforcement topologies, described above, may not sufficiently mitigate local high stresses occurring in the separation walls. As such, there is a need for improved concepts for reinforcement structures that can better resist higher forces and/or prevent cracks while improving mechanical robustness of the battery pack housing with respect to battery cell stack expansion.

According to one embodiment of the present disclosure, a battery pack is provided. The battery pack includes a battery pack housing with a plurality of accommodation spaces. A plurality of battery cell stacks is disposed in respective accommodation spaces. The battery pack includes a separation wall provided to separate adjacent battery cell stacks from each other. A pressure wall including a first side in contact with end portions of the battery cell stacks is connected or integrally formed with the separation wall. The battery pack further includes a reinforcement structure for reinforcing the separation wall which is provided on a second side of the pressure wall opposite to the first side. The reinforcement structure includes an outer wall spaced apart from the pressure wall and extending parallel to the pressure wall. The reinforcement structure includes a plurality of stiffening ribs between the pressure wall and the outer wall, the stiffening ribs contacting the outer wall and the pressure wall from a bottom portion in height direction. The stiffening ribs have a first contact height in contact with the pressure wall and a second contact height in contact with the outer wall which is less than a total pressure wall height of an upper edge of the pressure wall.

According to another embodiment of the present disclosure, a battery system including a battery pack as described above is provided.

According to another embodiment of the present disclosure, a vehicle is including a battery pack as described above is provided.

Further embodiments of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a perspective view of a battery pack according to an embodiment.

FIG. 2A is a partial perspective view of a battery pack according to a comparative embodiment showing stress distribution.

FIG. 2B is a partial cross-sectional view of a separation wall shown in FIG. 2A.

FIG. 3A is a partial perspective view of a battery pack according to an embodiment of the present disclosure.

FIG. 3B is a top view of a battery pack according to an embodiment of the present disclosure.

FIG. 3C is a cross-sectional view of the battery pack taken along the line A-A in FIG. 3B when viewed at an angle.

FIG. 3D is the same view as shown in FIG. 3C showing stress distribution.

FIG. 4A is a partial perspective view of a battery pack according to another embodiment of the present disclosure.

FIG. 4B is a side view of the battery pack shown in FIG. 4A according to the embodiment of the present disclosure.

FIG. 4C is a perspective view of a battery pack according to an embodiment of the present disclosure showing stress distribution.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described. The same reference numerals designate the same elements.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that although the terms “first” and “second” are used to describe various elements, these elements should not be limited by these terms. These terms are only used to distinguish one element from another element. For example, a first element may be named a second element and, similarly, a second element may be named a first element, without departing from the scope of the present disclosure.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being “above” or “on” another film, region, or element, it can be directly on the other film, region, or element, or intervening films, regions, or elements may also be present.

Herein, the terms “upper” and “lower” are defined according to the z-axis. For example, the upper cover is positioned at the upper part of the z-axis, and the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

According to an embodiment of the present disclosure, a battery pack includes a battery pack housing having a plurality of accommodation spaces. A plurality of battery cell stacks is respectively disposed (or arranged) in the accommodation spaces. The battery pack includes a separation wall to separate adjacent battery cell stacks from each other and a pressure wall have a first side in contact with end portions of the battery cell stacks and connected or integrally formed with the separation wall. The battery pack further includes a reinforcement structure on a second side of the pressure wall opposite to the first side for reinforcing the separation wall. The reinforcement structure includes an outer wall spaced apart from the pressure wall and extending parallel to the pressure wall. The reinforcement structure includes a plurality of stiffening ribs between the pressure wall and the outer wall. The stiffening ribs contact the outer wall and the pressure wall from a bottom portion of the battery pack housing in a height direction. The stiffening ribs have a first contact height in contact with the pressure wall and/or a second contact height in contact with the outer wall that is less than a total pressure wall height of an upper edge of the pressure wall.

The stiffening ribs are arranged between the pressure wall and the outer wall. The stiffening ribs may be an integral component of the housing. The stiffening rib may be, in other words, a reinforcement rib or stiffener rib. The stiffening ribs may include flat sheet members, for example, metal sheet members, but the present disclosure is not limited thereto. The stiffening ribs may transfer force from the pressure wall to the outer wall.

Thus, it would be expected that the structure should extend the stiffening ribs to the upper edge of the pressure wall such that the pressure wall can be optimally supported by the outer wall to reduce stress at the upper edge of the separation wall. However, such a design causes the tensile stress in the upper edge of the separation wall to remain critical. In addition, the dimensions of the separation wall and the rounded transition between the separation wall and the pressure wall are limited for packaging reasons.

According to embodiments of the present disclosure, as explained below, a non-intuitive and surprising solution is found and quantified by FEM analysis in which, due to the first contact height and/or the second contact height being less than a total pressure wall height of an upper edge of the pressure wall, the imposed stresses in the upper edge of the separation walls is significantly reduced. For example, by removing stiffening ribs in the upper portions of the pressure wall, the upper portions of the pressure wall become more elastic/flexible, thereby reducing an amount of stress imposed in the critical upper edge. This finding is supported by FEM analysis and stress tensor determination for the underlying topology. Therefore, higher forces can be resisted and/or crack formation prevented. Resisting higher forces may allow for larger cell format or less cell spacer thickness and, thus, increased energy density.

According to an embodiment, a first contact height and/or a second contact height is less than about 90% of the total pressure wall height, less than about 80% of the total pressure wall height, or less than about 70% of the total pressure wall height. This ensures that the effect of reducing the tensile stress in the upper edges of the separation wall is high enough to reduce the risk reaching critical (tensile) stress.

According to an embodiment, the stiffening ribs have a contact region corresponding to where the pressure wall contacts the separation wall having the first contact height. Thus, in this embodiment, the first contact height is directly located at where forces are induced into the separation wall. The height reduction of the stiffening rib at the contact region has an improved effect of reducing stress. For example, the maximum tension may be split into two force paths flowing into the separation wall at the contact region, resulting in reduction of tensile stress in the upper section of separation wall. The contact region (e.g., the contact area), in other words, refers to the region (e.g., the area) at where the pressure wall and the separation wall meet (e.g., where they contact). The contact region may have a vertically extending line-shaped area corresponding to the contacting side wall of the separation wall.

According to an embodiment, the stiffening ribs have a cut-out that extends to the first contact height in a direction opposite to the height direction, that is, in a direction toward the bottom. The cut-out may provide the reduced first contact height. The cut-out may be a region in which no material of the stiffening ribs contacts the pressure wall. The cut-out may correspond to the contact region. The cut-out of the stiffening ribs can reduce the tensile stress at the top edge of the separation wall to a tolerable level. For example, due to the cut-out, a maximum tension may split into two main force paths resulting in local stress reduction in the upper section of separation wall. This may be intuitively understood because due to the cut-out extending downwardly, the cut-out provides a higher flexibility in the upper portion. Due to the battery cell stack being slightly bulged outwardly, the pressure wall may flex outwards due to the missing of the stiffening rib. This may result in a second main force flow distanced below an upper first main force flow along the edge of the separation wall. Thus, by enabling the second main force flow, tensile stress at the upper edge of the separation wall is reduced.

According to an embodiment, the cut-out is formed so that a force exerted by the battery cell stacks onto the pressure wall is split into two height-separated main forces induced into the separation wall. This may lead to an area with reduced stress between the split force paths resulting in effective reduction of stress in the upper edge of the separation wall.

According to an embodiment, the cut-out is formed by removing a portion of the stiffening ribs. For example, the cut-out may be formed by a removal process of stiffening rib material. This can be easily retrofitted for battery packs, which may have stiffening ribs up to the upper edge of the pressure wall, or may be easily integrated in conventional manufacturing production after, for example, casting.

According to an embodiment, the stiffening ribs include at least one stiffening protrusion extending in height direction in contact with the pressure wall toward the upper edge with respect to a bottom, that is, the lowest point, of the cut-out. The at least one stiffening protrusion is located laterally displaced from a contact region corresponding to where the pressure wall contacts the separation wall. The stiffening protrusion, such as a stiffening finger, may ensure a high enough force flow in the upper edge of the separation wall to counteract outward bending of the upper portion of the pressure wall.

According to an embodiment, the stiffening ribs form two uncovered portions on the second side of the pressure wall, which are separated from each other by a contact portion of the stiffening ribs contacting the pressure wall at the contact region corresponding to where the pressure wall contacts the separation wall. This configuration may further stabilize the structure of the separation wall.

According to an embodiment, the outer wall has a total outer wall height that is less than the total pressure wall height of the upper edge of the pressure wall. According to an embodiment, the total outer wall height of the outer wall corresponds to the second contact height. As such, because the outer wall is reduced and the height of the stiffening ribs is reduced in a direction away from the separation wall, a reduction of the stress imposed in the upper portion of the separation wall is achieved.

According to an embodiment, a local height of the stiffening ribs continuously reduces from the first contact height toward the second contact height of the first outer wall. Thus, larger forces can be accommodated in the stiffening ribs.

According to an embodiment, a descending slope of the stiffening ribs is smaller in a first region of the pressure wall and steeper in a second region of the outer wall. This optimizes force input in the stiffening ribs and reduces the occurrence of high stresses.

According to an embodiment, the stiffening ribs include a first branched rib portion and a second branched rib portion connected with the pressure wall at the location corresponding to where the pressure wall contacts the separation wall and extending toward the outer wall from this location by being branched with an angle (e.g., a titled angle) with respect to an extension direction of the separation wall. Thus, two force flows may be provided to split to each of the branched rib portions. This optimizes force input in the stiffening ribs and reduces load on the separation wall.

According to an embodiment, the battery pack housing is cast. For example, the battery pack housing may be high pressure die cast. Die casting refers to a metal casting process by forcing molten metal under high pressure into a mold cavity. For example, the battery pack housing may include aluminum. The cast battery pack housing may provide excellent surface properties.

According to an embodiment, the plurality of stiffening ribs is integrally formed with the pressure wall and the outer wall. Thus, additional stresses at material transitions may be avoided.

According to an embodiment of the present disclosure, a battery system is provided including a battery pack as described herein.

According to an embodiment of the present disclosure, a vehicle is provided including a battery pack as described herein.

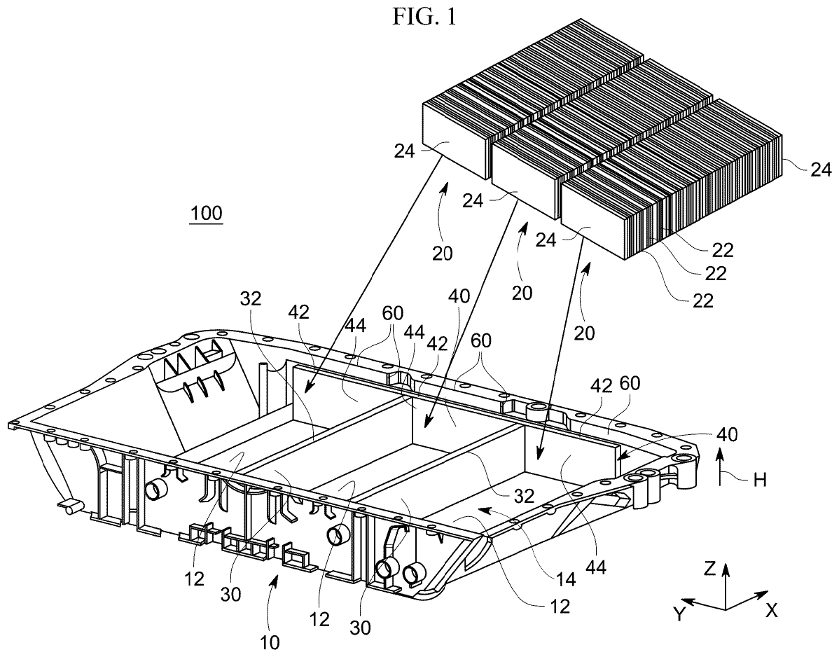

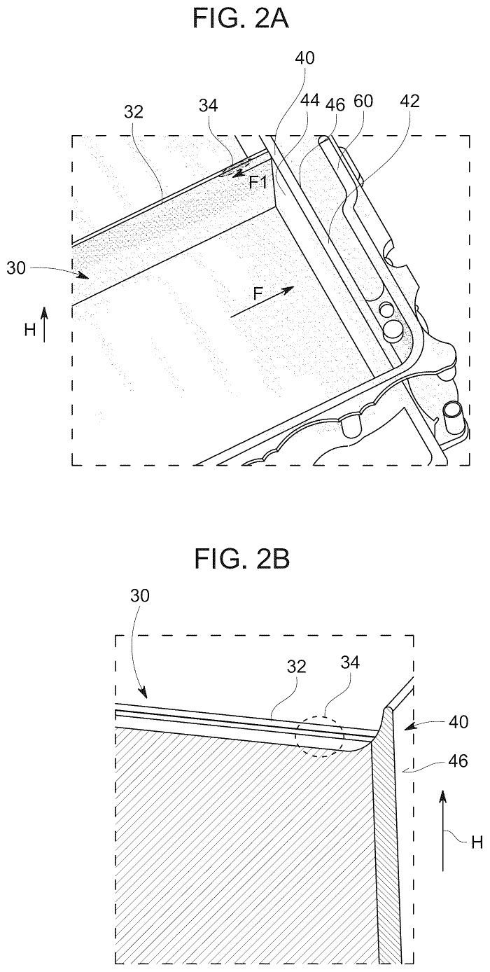

FIG. 1 is a perspective view of a battery pack 100 including a battery pack housing 10 and a battery cell stack 20 according to an embodiment. FIG. 2A is a partial perspective view of a comparative battery pack showing stress distribution. FIG. 2B is a partial cross-sectional view of a separation wall 30 shown in FIG. 2A.

Referring to FIG. 1, the battery pack housing 10 has a plurality of accommodation spaces 12. In this embodiment, three accommodation spaces 12 are provided, but the present disclosure is not limited thereto.

As illustrated in FIG. 1, a plurality of battery cell stacks 20 are provided. The battery cell stacks 20 are disposed in respective accommodation spaces 12 (such arranging is indicated by lines and for convenience, the battery cell stack 20 is omitted in FIG. 2A). The battery cell stacks 20 are coupled to the battery pack housing 10, for example, mechanically and/or adhesively. The battery cell stack 20 may be directly coupled to the battery pack housing 10. In this embodiment, a module frame may be omitted, but the present disclosure is not limited thereto. Each battery cell stack 20 includes a plurality of battery cells 22.

The battery pack housing 10 further includes a separation wall 30. The separation wall 30 separates adjacent battery cell stacks 20 from each other. In this embodiment, two separation walls 30 are provided separating the three battery cell stacks 20 from each other. In other embodiments, a single or more than two separation walls 30 may be provided.

The battery pack housing 10 further includes a pressure wall 40. The pressure wall 40 has a first side 44 in contact with end portions 24 of the battery cell stack 20 when the battery cell stack 20 is disposed in accommodation space 12. For example, two pressure walls 40 may be respectively provided on opposite end portions 24 of the battery cell stack 20. Thus, for example, both end portions 24 of the battery cell stack 20 may be in contact with a respective pressure wall 40. The pressure wall 40 is connected or integrally formed with the separation wall 30. The battery cell stack 20 may exert a force F (see, e.g., FIG. 2A) onto the pressure wall 40. The force F may be due to, for example, battery cell swelling, aging, or charging. The force F acting on the pressure wall 40 needs to be resisted by the battery pack housing 10 and the separation wall 30 as explained in more detail below.

Further, as shown in FIG. 1, the battery pack housing 10 includes an outer wall 60. The outer wall 60 is spaced apart from a second side 46 of the pressure wall 40, for example, by a distance (e.g., by a predetermined distance). The outer wall 60 may extend in a direction parallel or substantially parallel to the pressure wall 40. Therefore, a distance between the pressure wall 40 and the outer wall 60 may be constant (or substantially constant) along and with respect to the pressure wall 40.

The battery pack housing 10 may be cast (e.g., may be a cast component), for example, high pressure casted. For example, the pressure wall 40 and the outer wall 60 may be integrally formed in the casting. As such, an integrated battery pack housing 10 may be obtained reducing material and complexity, for example, by reducing or omitting fastening members for manufacturing and reducing imposed stresses at mechanical connections.

Referring to FIG. 2A, a perspective view of a comparative embodiment of a battery pack housing is illustrated along with calculated stress distribution (e.g., tensile stress) to show induced local tensile stresses. FIG. 2B is a perspective view of a separation wall 30 of the comparative battery pack housing shown in FIG. 2A. The distribution of tensile stresses imposed in the components of the battery pack housing 10 shown in FIG. 2A may be obtained by simulation using finite element method (FEM).

FIG. 2A illustrates the stress response as a distribution of stresses of the separation wall 30 and the pressure wall 40 responding to a force F exerted by the battery cell stack 20 on the pressure wall 40. The force F may be due to swelling of battery cells, charging of battery cells, or aging, but the present disclosure is not limited thereto. The comparative example may include stiffening ribs (not shown in FIGS. 2A and 2B) between pressure wall 40 and outer wall 60, which extend from a bottom portion 14 of the battery pack housing 10 up to the total pressure wall height Hp to reduce tensile stresses acting on the separation wall 30.

However, as illustrated in FIG. 2A, high stresses, for example, tensile stresses, are imposed in the separation wall 30 between the battery cell stacks 20. For example, the tensile stresses increase in a height direction H and close to the contact region between the separation wall 30 and the pressure wall 40 on the upper edge 32 of the separation wall 30.

Referring in detail to FIG. 2A, FEM analysis reveals that even if stiffening ribs are extended up to the upper edge 42 of the pressure wall 40, a local maximum of tensile stress occurs at the upper edge 32 of the separation wall 30. A main force F1 in FIG. 2A represents the force entry to the separation wall 30. This main force F1 causes a critical area 34 having maximum tensile stress, which is illustrated in FIG. 2A, where the stress tensor exhibits a maximum. The critical area 34 is also illustrated in FIG. 2B by the indicated circle. Thus, the force F exerted by the battery cell stack 20 may cause to critical stress in the upper edge 32 of the separation wall 30, which may result in lower stress resistance and/or crack formation in the separation wall 30.

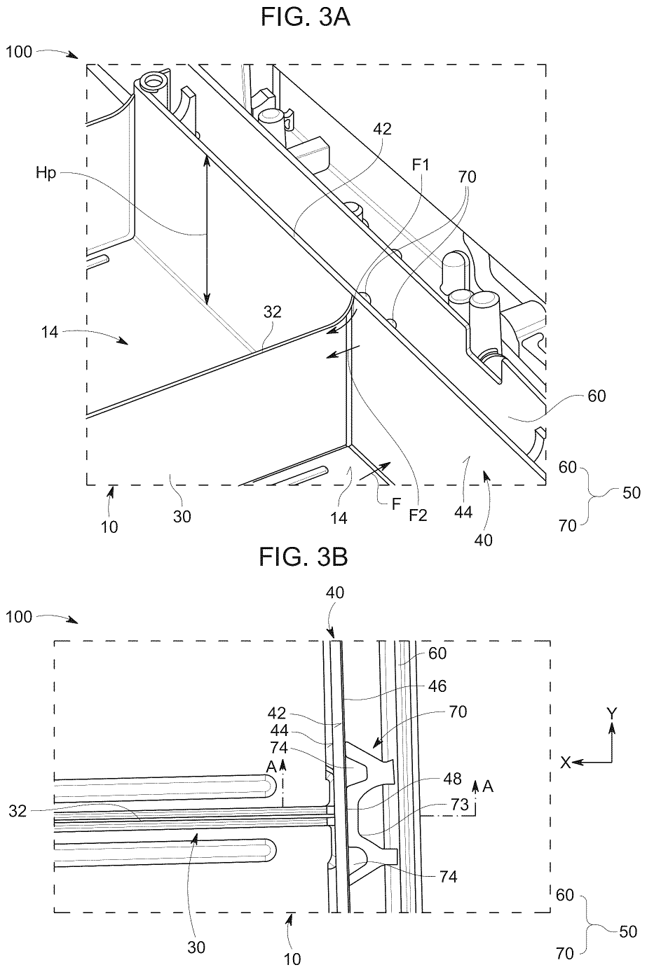

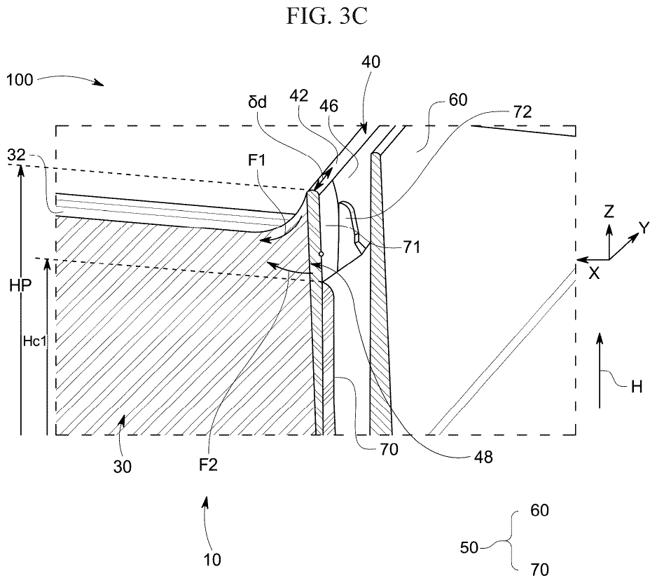

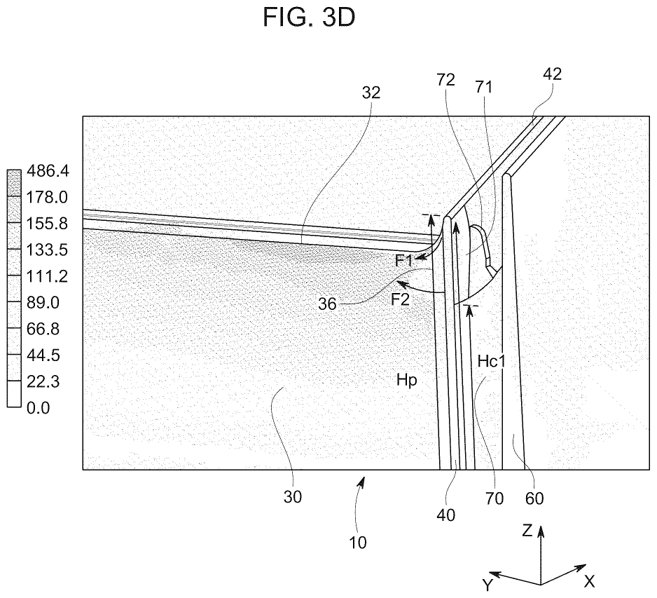

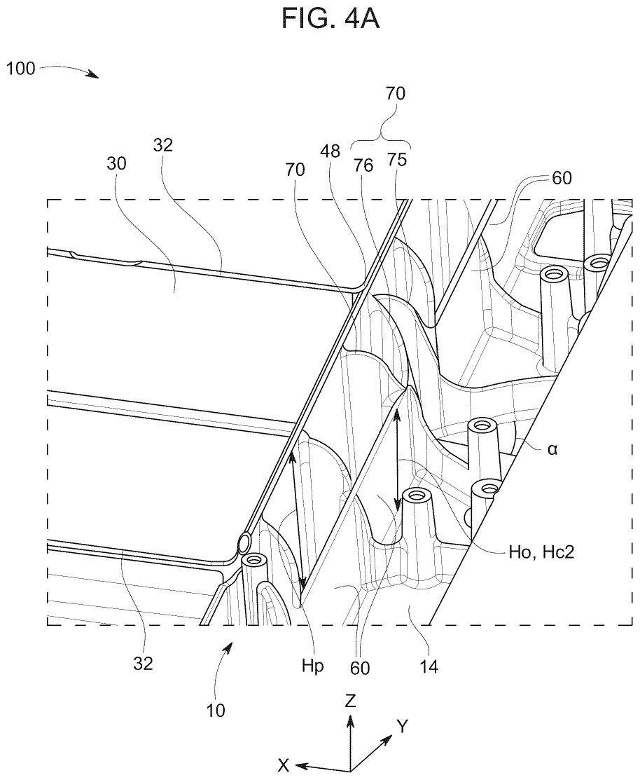

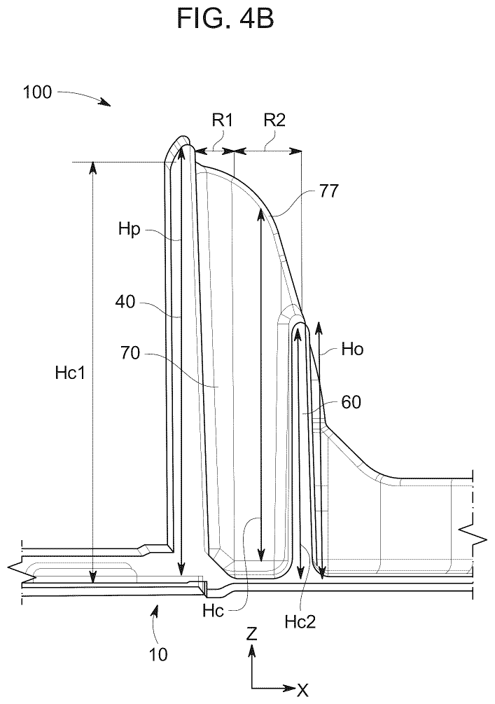

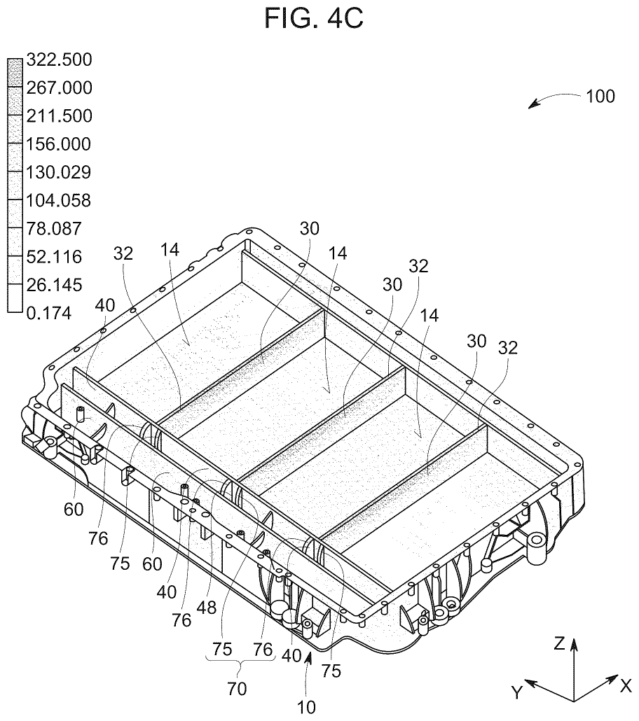

According to various embodiments of the battery pack 100 as described below respect to FIGS. 3A-3D and FIGS. 4A-4D, the tensile stress in the upper edge 32, for example, the critical area 34, of the separation wall 30 is reduced and, thus, stress resistance of the battery pack 100 is improved and/or crack formation is prevented. A simulation methodology, such as topology optimization, may be used as tool resulting in the described structural topologies for reducing stresses at a critical position, thus enabling the battery pack housing 10 to resist higher forces.

FIG. 3A is a partial perspective view of a battery pack 100 according to an embodiment. FIG. 3B is a top view of the battery pack 100 shown in FIG. 3A. FIG. 3C is a cross-sectional view of the battery pack 100 taken along the line A-A when viewed at an angle. FIG. 3D us the same view as shown in FIG. 3C and illustrates stress distribution.

The battery pack 100 includes a reinforcement structure 50. The reinforcement structure 50 reinforces the separation wall 30 against induced forces as described above. For example, the reinforcement structure 50 reduces the tensile stress in the upper edge 32, that is, at the critical area 34 (see, e.g., FIG. 2B) of the separation wall 30.

The reinforcement structure 50 is provided on the second side 46 of the pressure wall 40 opposite to the first side 44. The reinforcement structure 50 includes the outer wall 60, which is spaced apart from the pressure wall 40 and extends parallel to the pressure wall 40.

The reinforcement structure 50 also includes a plurality of stiffening ribs 70 between the pressure wall 40 and the outer wall 60. The stiffening ribs 70 may be integrally formed with the pressure wall 40 and/or outer wall 60 as part of the casting process.

The stiffening ribs 70 contact (e.g., extend between) the outer wall 60 and the pressure wall 40. For example, as shown in the top view of FIG. 4B, the stiffening ribs 70 extend according to a topology to the outer wall 60.

With respect to the pressure wall 40, the stiffening ribs 70 extend from a bottom portion 14 (see, e.g., FIG. 3A) in height direction H of the battery pack housing 10.

Referring now to FIG. 3C, the stiffening ribs 70 have a first contact height Hc1 in contact with the pressure wall 40. The first contact height Hc1 is the height of the stiffening ribs 70 that is in contact with the pressure wall 40 on the second side 46 of the pressure wall 40.

According to the illustrated embodiment, the first contact height Hc1 of the stiffening ribs 70 is less than a total pressure wall height Hp of an upper edge 42 of the pressure wall 40. For example, a gap is provided between the upper edge 42 of the pressure wall 40 and an upper end of the stiffening ribs 70.

Thus, compared to the conventional example where the stiffening ribs 70 extend to the top of the upper edge 42 of the pressure wall 40, the stiffening ribs 70 according to an embodiment of the present disclosure does not extend to the top of the upper edge 42 of the pressure wall 40 (e.g., has an upper edge that is spaced apart from the top of the upper edge 42 of the pressure wall 40 in the height direction).

FEM results confirm that as a non-intuitive effect caused by the height-reduction of the stiffening ribs 70, the stress induced into the upper edge 32 of the separation wall 30 is reduced. This finding is supported by the FEM results as shown in FIG. 3D, showing that the tensile stress in the upper edge 32 of the separation wall 30 is reduced. As such, higher forces can be resisted by the battery pack housing 10 and potential cracks prevented.

According to the example embodiment in FIGS. 3A to 3D, the upper edge 42 of the pressure wall 40 may be higher than (e.g., may be above) the upper edge 32 of the separation wall 30. For example, the contact height Hc1 may be less than (or lower than) the upper edge 32 of the separation wall 30. In other embodiments, the upper edge 42 of the pressure wall 40 may be equal in height compared to the upper edge 32 of the separation wall 30.

The first contact height Hc1 may be less than about 90% of the total pressure wall height Hp of the pressure wall 40. In another embodiments, the first contact height Hc1 may be less than about 80% of the total pressure wall height Hp may be less than about 70% of the total pressure wall height Hp. As such, significant tensile reduction can be achieved.

Referring to FIGS. 3B and 3C, the stiffening ribs 70 have the first contact height Hc1 in contact with the pressure wall 40 at a contact region 48 corresponding to where the pressure wall 40 contacts the separation wall 30. The contact region 48 (e.g., the contact area) refers to the region (e.g., an area) at where the pressure wall 40 and the separation wall 30 meet (e.g., where they contact each other). The contact region 48 may have a vertically extending line-shaped area corresponding to the contacting side wall of the separation wall 30. Thus, the height reduction of the stiffening ribs 70, for example, where first contact height Hc1 is measured, occurs directly at the location where forces are applied to the separation wall 30. As such, the stresses in the upper edge 32 of the separation wall 30 can be reduced.

The height reduction of the stiffening ribs 70 may be formed by a cut-out 71. The cut-out 71 may extend to the first contact height Hc1 in a direction opposite to the height direction H at the pressure wall 40. Thus, the cut-out 71 may provide the reduced first contact height Hc1. The cut-out 71 may define (e.g., provide) a region (e.g., a contact area) in which no material of the stiffening ribs 70 contacts the pressure wall 40. The cut-out 71 may correspond to the contact region 48.

The cut-out 71 is indicated in in FIG. 3C. Due to the section view, only half of the cut-out 71 is shown in FIG. 3C. The cut-out 71 extends in a bottom direction, for example, opposite to the height direction H. As shown in FIG. 3D, the cut-out 71 may cause the induced main forces F1, F2 applied to the separation wall 30 to split.

Due to the cut-out 71, the force F exerted by the battery cell stacks 20 onto the pressure wall 40 causes two height-separated first and second main forces F1, F2 to be applied to the separation wall 30. The main forces F1, F2 are shown in FIG. 3D, where a reduced stress area 36 is formed by the cut-out 71 between the main forces F1, F2. Thereby, tensile stress in the upper edge 32 (e.g., at the critical area 34 as indicated in FIG. 2B) is reduced. As such, crack formation may be prevented and stress resistance increased.

In an embodiment, the cut-out 71 is a removed portion of the stiffening ribs 70. Thus, the cut-out 71 can be retrofitted to battery packs where the stiffening ribs 70 reach the upper edge 42 of the pressure wall 40 by a cutting operation performed to remove material of the stiffening ribs 70, for example, at the contact region 48. This may allow production of the battery pack 100 with already existing manufacturing methods by adding a cutting or removal operation.

The boundary of the cut-out 71 may be provided with a stiffening protrusion 72. For example, as shown in FIG. 3C, the stiffening rib 70 includes at least one stiffening protrusion 72 extending in height direction H and in contact with the pressure wall 40, for example, two stiffening protrusions 72, one on each side of the cut-out 71, may be provided. The stiffening protrusions 72 extend in the height direction H in contact with the pressure wall 40. Thus, the stiffening protrusions 72 extend in direction toward the upper edge 42, while maintaining a distance therefrom, with respect to the bottom portion 14. The stiffening protrusion 72 is located to be laterally displaced, by a displacement bd, from the contact region 48 corresponding to where the pressure wall 40 contacts the separation wall 30. The stiffening protrusion 72 may also define the boundary, or envelope, of the cut-out 71. The stiffening protrusions 72 may maintain a high enough force flow in the separation wall 30 to counteract any outward bending of the upper portions of the pressure wall 40.

Further, referring to FIG. 3B, a specific topology of the stiffening ribs 70 may be provided to further stabilize the structure. The stiffening ribs 70 form two uncovered portions 74 on the second side 46 of the pressure wall 40. The uncovered portions 74 are separated from each other by a contact portion 73 of the stiffening ribs 70 contacting the second side 46 of the pressure wall 40 at the contact region 48 corresponding to where the pressure wall 40 contacts the separation wall 30. The uncovered portions 74 may be provided by (or formed by) the stiffening ribs 70 forming branches between pressure wall 40 and outer wall 60 that are angled with respect to the separation wall 30. This topology may further stabilize the structure of the separation wall 30.

In the following, another embodiment is described with reference to FIGS. 4A -4C, which can reduce the tensile stress in the upper edge 32 of the separation wall 30.

FIG. 4A is a partial perspective view of a battery pack 100 according to an embodiment of the present disclosure. FIG. 4B is a side view of the battery pack 100 shown in FIG. 4A. FIG. 4C is a perspective view of the battery pack 100 shown in FIGS. 4A and 4B illustrating a stress distribution. In the following, the differences with respect to the embodiment described above with respect to FIGS. 3A-3D will be primarily described while the description of the same features is omitted or only briefly repeated.

In this embodiment, with reference to FIG. 4A, the reinforcement structure 50 includes the plurality of stiffening ribs 70 between the pressure wall 40 and the outer wall 60 having a different configuration. The stiffening ribs 70 contact the outer wall 60 and the pressure wall 40 and extend from the bottom portion 14 in a height direction H of the battery pack housing 10.

Referring to FIGS. 4A and 4B, in this embodiment, the second contact height Hc2 of the stiffening ribs 70 in contact with the outer wall 60 is less than a total pressure wall height Hp of the upper edge 42 of the pressure wall 40. Thus, the second contact height Hc2 of the stiffening ribs 70 in contact with the outer wall 60 is not equal to the total pressure wall height Hp of the upper edge 42 to reduce the stress of the separation wall 30.

According to illustrated embodiment of the present disclosure and as demonstrated the stress analysis of the battery pack shown in FIG. 4C obtained by FEM analysis, the amount of stress in the upper edge 32 of the separation wall 30 is reduced and the critical areas 34 as indicted in FIG. 2A can be avoided. By this configuration, main forces are transferred away through the stiffening ribs 70 that are height-reduced at the outer wall 60. Thus, by the height relation, stresses occur in the stiffening ribs 70 rather than at the upper edge 32 of the separation wall 30 as shown in FIG. 4C.

For example, the second contact height Hc2 may be less than about 90% of the total pressure wall height Hp, less than about 80% of the total pressure wall height Hp, or less than about 70% of the total pressure wall height Hp. As such, an effect of reducing the tensile stress in the upper edge 32 may be achieved.

As shown in more detail in FIG. 4B, the outer wall 60 may have total outer wall height Ho that is less than the total pressure wall height Hp of the upper edge 42 of the pressure wall 40. For example, the total outer wall height Ho of the outer wall 60 may correspond to, for example, may be equal to, the second contact height Hc2. As such, the pressure exerted by the battery cell stack 20 may be guided downwardly towards the outer wall 60, which is reduced in height.

As shown in FIGS. 4A and 4B, a local height Hc of the stiffening ribs 70 may continuously reduce from the first contact height Hc1 at the pressure wall 40 toward the second contact height Hc2 at the outer wall 60. As such, local high stresses in the stiffening ribs 70 may be avoided.

According to an embodiment, the stiffening ribs 70 may have a descending slope 77 of the stiffening ribs 70, which is smaller in a first region R1 closer to the pressure wall 40 than in a second region R2, that is, relative the first region R1, closer to the outer wall 60. This may be the result of topology optimization of the stiffening ribs 70 avoiding high stresses in the stiffening ribs 70 in the vicinity of the contact region 48.

Referring to FIG. 4A, the stiffening ribs 70 include a first branched rib portion 75 and a second branched rib portion 76 connected and/or contacting with the pressure wall 40 at the contact region 48 corresponding to where the pressure wall 40 contacts the separation wall 30. The first branched rib portion 75 and the second branched rib portion 76 may extend toward the outer wall 60 from the contact region 48 by being branched with an angle α with respect to an extension direction of the separation wall 30. As such, forces may be distributed over the branched portions 75, 76 directly from the contact region 48. As such and as shown in FIG. 4D, imposed tensile stresses in the upper edge 32 of the separation wall 30 are reduced.

As mentioned above, the battery pack housing 10 may be casted. The plurality of stiffening ribs 70 may be integrally formed with the pressure wall 40 and the outer wall 60 to form the battery pack housing 10.

Further, a battery system and vehicle may be provided including the battery pack 100 according to the above-described embodiments.

In summary, embodiments of the battery pack 100 are described with respect to FIGS. 3A-3D and FIGS. 4A-4C that reduce the tensile stress occurring in an upper edge 32, that is, the critical area 34, of the separation wall 30 to improve stress resistance of the battery pack 100 and/or to prevent crack formation.

### DESCRIPTION OF SOME REFERENCE SIGNS

100 battery pack
10 battery pack housing
12 accommodation space
14 bottom portion
20 battery cell stack
22 battery cell
24 end portion
30 separation wall
32 upper edge
34 critical area
36 reduced stress area
40 pressure wall
42 upper edge
44 first side
46 second side
48 contact region
δd displacement
Hp total pressure wall height
50 reinforcement structure
60 outer wall
Ho total outer wall height
70 stiffening rib
71 cut-out
72 stiffening protrusion
73 contact portion
74 uncovered portion
75 first branched rib portion
76 second branched rib portion
77 descending slope
R1 first region (lower slope)
R2 second region (higher slope)
α angle
F force
F1 first main force
F2 second main force
Hc1 first contact height
Hc2 second contact height
Hc (local) height
H height direction

What is claimed is:

1. A battery pack comprising:
a battery pack housing having a plurality of accommodation spaces respectively accommodating a plurality of battery cell stacks therein;
a separation wall separating adjacent ones of the battery cell stacks from each other;
a pressure wall having a first side contacting end portions of the battery cell stacks and connected to or integrally formed with the separation wall; and
a reinforcement structure for reinforcing the separation wall, the reinforcement structing being on a second side of the pressure wall opposite to the first side, the reinforcement structure comprising:
an outer wall spaced from the pressure wall and extending parallel to the pressure wall; and
a plurality of stiffening ribs between the pressure wall and the outer wall, the stiffening ribs contacting the outer wall and the pressure wall from a bottom portion in height direction,
wherein the stiffening ribs have a first contact height in contact with the pressure wall and a second contact height in contact with the outer wall that is less than a total pressure wall height to an upper edge of the pressure wall.

2. The battery pack as claimed in claim 1, wherein the first contact height and the second contact height are less than 90% of the total pressure wall height.

3. The battery pack as claimed in claim 1, wherein the stiffening ribs contacts the pressure wall at a contact region corresponding to where the pressure wall contacts the separation wall at the first contact height.

4. The battery pack as claimed in claim 3, wherein the stiffening ribs has a cut-out extending from the upper edge of the pressure wall to the first contact height in a direction opposite to the height direction at the pressure wall in which no material of the stiffening ribs contacts the pressure wall.

5. The battery pack as claimed in claim 4, wherein the cut-out is configured such that a force exerted by the battery cell stacks onto the pressure wall is split into two height-separated main forces in the separation wall.

6. The battery pack as claimed in claim 4, wherein the cut-out is a removed portion of the stiffening ribs.

7. The battery pack as claimed in claim 4, wherein the stiffening ribs comprise a stiffening protrusion extending in height direction and contacting the pressure wall with respect to the cut-out, and
wherein the stiffening protrusion is located laterally displaced from a contact region corresponding to where the pressure wall contacts the separation wall.

8. The battery pack as claimed in claim 1, wherein the outer wall has a total outer wall height that is less than the total pressure wall height of the pressure wall.

9. The battery pack as claimed in claim 8, wherein the total outer wall height of the outer wall corresponds to the second contact height.

10. The battery pack as claimed claim 8, wherein a local height of the stiffening ribs continuously reduces from the first contact height toward the second contact height of the outer wall.

11. The battery pack as claimed in claim 10, wherein a descending slope of the stiffening ribs is smaller in a first region closer to the pressure wall than in a second region closer to the outer wall.

12. The battery pack as claimed in claim 8, wherein the stiffening ribs comprise a first branched rib portion and a second branched rib portion connected with the pressure wall at a contact region corresponding to where the pressure wall contacts the separation wall and extending toward the outer wall from the contact region by being branched with an angle with respect to an extension direction of the separation wall.

13. The battery pack as claimed in claim 1, wherein in the battery pack housing is cast.

14. The battery pack as claimed in claim 1, wherein plurality of stiffening ribs is integrally formed with the pressure wall and the outer wall.

15. A battery system comprising the battery pack as claimed in claim 1.
